(19) United States
(12) Patent Application Publication
(10) Pub. No.: US 2014/0329941 A1
(43) Pub. Date: Nov. 6, 2014

(54) LIQUID CRYSTAL ALIGNMENT AGENT, LIQUID CRYSTAL ALIGNMENT FILM AND LIQUID CRYSTAL DISPLAY ELEMENT HAVING THEREOF

(71) Applicant: CHI MEI CORPORATION, Tainan City (TW)

(72) Inventor: Wei-Lun CHANG, YUNLIN COUNTY (TW)

(73) Assignee: CHI MEI CORPORATION, Tainan City (TW)

(21) Appl. No.: 14/254,906

(22) Filed: Apr. 17, 2014

(30) Foreign Application Priority Data
May 3, 2013 (TW) 102115899

(51) Int. Cl. C08K 5/3415; C08K 5/06

(52) U.S. Cl. CPC C08K 5/3415; C08K 5/06
USPC 524/104

(57) ABSTRACT

The present invention relates to a liquid crystal alignment agent, a liquid crystal alignment film made by the liquid crystal alignment agent and a liquid crystal display element having the liquid crystal alignment film. The liquid crystal alignment agent comprises a polymer (A) and a solvent (B). The polymer (A) is obtained by reacting a mixture that includes a tetracarboxylic dianhydride component (a) and a diamine component (b). The aforementioned liquid crystal alignment agent has excellent process stability and the charge accumulation can be rapidly relaxed.

### RELATED APPLICATIONS

This application claims priority to Taiwan Application Serial Number 102115899, filed on May 3, 2013, which is herein incorporated by reference.

### BACKGROUND

1. Field of Invention

The present invention relates to a liquid crystal alignment agent, a liquid crystal alignment film and a liquid crystal display element having thereof. More particularly, the present invention relates a liquid crystal alignment agent that can rapidly relax the charge accumulation and have excellent process stability, a liquid crystal alignment film formed by the liquid crystal alignment agent, and a liquid crystal display element comprises the liquid crystal alignment film.

2. Description of Related Art

In recent years, there is an improvement in the requirements of the displaying quality of the liquid crystal display element, thereby the quality and the properties (such as the alignment property of the liquid crystal, voltage holding ratio, residual charge and the like) of the liquid crystal alignment agent are much emphasized. When the residual charge is high, an image sticking of the liquid crystal display element is easily induced. The aforementioned image sticking means that the original image will be stuck and will not disappear after the voltage is applied and then removed. The aforementioned image sticking is overlapped a new image, so as to lower the displaying quality.

JP2004-86184 discloses a liquid crystal alignment agent having a low residual charge and high voltage holding ratio. The liquid crystal alignment agent includes a polyamic acid, which is synthesized with a 15 mole % to 35 mole % of aromatic tetracarboxylic dianhydride, 85 mole % is 65 mole % of aliphatic or cycloaliphatic tetracarboxylic dianhydride and diamine compound without long side chain. However, when a liquid crystal alignment film made by the aforementioned liquid crystal alignment agent is used in a liquid crystal display element, the liquid crystal display element still has the defect of low relaxation of charge accumulation to raise the residual charge, thereby forming the image sticking.

In addition, when the aforementioned liquid crystal alignment agent is printed, the process stability is lower, so as to raise the defective ratio in the following manufacturing processes. Accordingly, there is a need to improve the aforementioned disadvantages for the requirements of the liquid crystal alignment agent.

### SUMMARY

Therefore, an aspect of the present invention provides a liquid crystal alignment agent. The liquid crystal alignment agent comprises a polymer (A) and a solvent (B). The liquid crystal alignment agent can improve the defects that the relaxation of charge accumulation is slow and process stability is bad.

Another aspect of the present invention provides a liquid crystal alignment film. The liquid crystal alignment film is formed by the aforementioned liquid crystal alignment agent.

A further aspect of the present invention provides a liquid crystal display element. The liquid crystal display element includes the aforementioned liquid crystal alignment film.

The liquid crystal alignment agent comprising a polymer (A) and a solvent (B) all of which are described in details as follows.

### Polymer (A)

The polymer (A) is selected from he group consisting of polyamic acid, polyimide, polyimide series block-copolymer and a combination thereof. The polyimide series block-copolymer is selected from the group consisting of polyamic acid block-copolymer, polyimide block-copolymer, polyamic acid-polyimide block-copolymer and a combination thereof.

The polyamic acid, polyimide, and polyimide series block-copolymer of the polymer (A) all synthesized by reacting a mixture that includes a tetracarboxylic dianhydride component (a) and a diamine component (b). The tetracarboxylic dianhydride component (a), a diamine component (b) and a method of producing the polymer (A) all of which are described in details as follows.

### Tetracarboxylic Dianhydride Component (a)

Tetracarboxylic Dianhydride Compound (a-1)

Tetracarboxylic dianhydride component (a) comprises at least one tetracarboxylic dianhydride compound (a-1) consisting of the group of a structure of the formula (I-1) to (I-3):

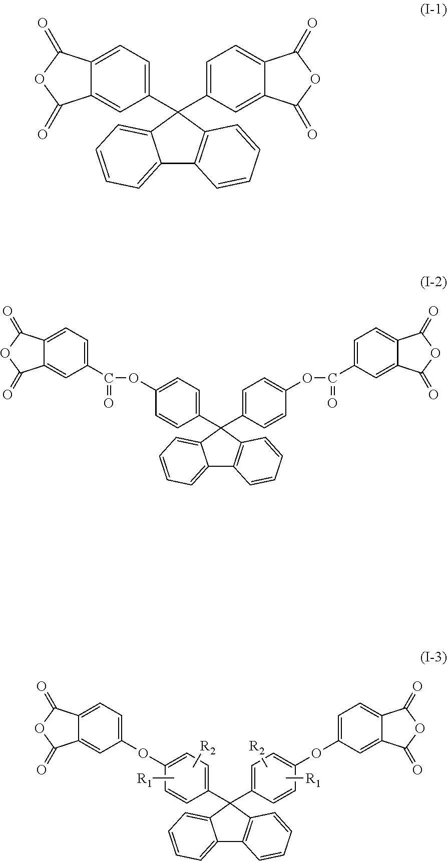

in the formula (I-3), R₁ is a hydrogen atom, an alkyl group of 1 to 6 carbons (for example the alkyl group such as methyl, ethyl, n-propyl,isopropyl,n-butyl,isobutyl,sec-butyl,tert-butyl,n-pentyl,n-hexyl and the like) and an aryl group having a single-ring or a condensed poly-ring of 6 to 14 carbons (for example the aryl group such as phenyl, o-tolyl, m-tolyl, p-tolyl, 1-naphthyl, 2-naphthyl, 1-anthryl, 2-anthryl, 9-anthryl and the like). Preferably, R₁ is methyl, ethyl, isopropyl, tert-butyl and phenyl. In formula (I-3), R₂ is a hydrogen atom, and R₂ can be the same as R₁. Preferably, R₂ is a hydrogen atom, methyl, ethyl, isopropyl, tert-butyl and phenyl. More preferably, R₂ is a hydrogen atom.

For example, the formula (I-3) is 9,9-bis[4-(3,4-dicarboxyphenoxy)phenyl]fluorene dianhydride, 9,9-bis[4-(3,4-dicarboxyphenoxy)-3-phenylphenyl]fluorene dianhydride, 9,9-bis[4-(2,3-dicarboxyphenoxy)-3-phenylphenyl]fluorene dianhydride, 9,9-bis[4-(3,4-dicarboxyphenoxy)-2-phenylphenyl]fluorene dianhydride, 9,9-bis[4-(2,3-dicarboxyphenoxy)-2-phenylphenyl]fluorene dianhydride, 9,9-bis[4-(3,4-dicarboxyphenoxy)-3-methylphenyl]fluorene dianhydride, 9,9-bis[4-(2,3-dicarboxyphenoxy)-3-methylphenyl]fluorene dianhydride, 9,9-bis[4-(3,4-dicarboxyphenoxy)-2-methylphenyl]fluorene dianhydride, 9,9-bis[4-(2,3-dicarboxyphenoxy)-2-methylphenyl]fluorene dianhydride, 9,9-bis[4-(3,4-dicarboxyphenoxy)-3-ethylphenyl]fluorene dianhydride, 9,9-bis[4-(2,3-dicarboxyphenoxy)-3-ethylphenyl]fluorene dianhydride, 9,9-bis[4-(3,4-dicarboxyphenoxy)-2-ethylphenyl]fluorene dianhydride, 9,9-bis[4-(2,3-dicarboxyphenoxy)-2-ethylphenyl]fluorene dianhydride, 9,9-bis[4-(3,4-dicarboxyphenoxy)-3-propylphenyl]fluorene dianhydride, 9,9-bis[4-(2,3-dicarboxyphenoxy)-3-propylphenyl]fluorene dianhydride, 9,9-bis[4-(3,4-dicarboxyphenoxy)-2-propylphenyl]fluorene dianhydride, 9,9-bis[4-(2,3-dicarboxyphenoxy)-2-propylphenyl]fluorene dianhydride, 9,9-bis[4-(3,4-dicarboxyphenoxy)-3-buthylphenyl]fluorene dianhydride, 9,9-bis[4-(2,3-dicarboxyphenoxy)-3-buthylphenyl]fluorene dianhydride, 9,9-bis[4-(3,4-dicarboxyphenoxy)-2-buthylphenyl]fluorene dianhydride, 9,9-bis[4-(2,3-dicarboxyphenoxy)-2-buthylphenyl]fluorene dianhydride, 9,9-bis[4-(3,4-dicarboxyphenoxy)-3-t-buthylphenyl]fluorene dianhydride, 9,9-bis[4-(2,3-dicarboxyphenoxy)-3-t-buthylphenyl]fluorene dianhydride, 9,9-bis[4-(3,4-dicarboxyphenoxy)-2-t-buthylphenyl]fluorene dianhydride, 9,9-bis[4-(2,3-dicarboxyphenoxy)-2-t-buthylphenyl]fluorene dianhydride and the like. Preferably, the formula (I-3) is 9,9-bis[4-(3,4-dicarboxyphenoxy)-3-phenylphenyl]fluorene dianhydride, 9,9-bis[4-(3,4-dicarboxyphenoxy)-2-phenylphenyl]fluorene dianhydride, 9,9-bis[4-(3,4-dicarboxyphenoxy)-3-methylphenyl]fluorene dianhydride, and 9,9-bis[4-(3,4-dicarboxyphenoxy)-2-methylphenyl]fluorene dianhydride.

Based on the tetracarboxylic dianhydride component (a) as 100 moles, the amount of the tetracarboxylic dianhydride compound (a-1) is 20 moles to 100 moles, preferably is 30 moles to 90 moles, and more preferably is 40 moles to 80 moles.

When the amount of the tetracarboxylic dianhydride compound (a-1) is 20 moles to 100 moles, the liquid crystal alignment agent can further improve the process stability.

Other Tetracarboxylic Dianhyrate Compound (a-2)

The tetracarboxylic dianhydride component (a) of the present invention can selectively combine the other tetracarboxylic dianhydride compound (a-2) besides the tetracarboxylic dianhydride compound (a-1).

The other tetracarboxylic dianhydride compound (a-2) can be selected from the group consisting of an aliphatic tetracarboxylic dianhydride compound, an alicyclic tetracarboxylic dianhydride compound, an aromatic tetracarboxylic dianhydride compound and the other tetracarboxylic dianhydride compound (a-2) having a structure of formula (I-4) to (I-9). The aforementioned other tetracarboxylic dianhydride compound (a-2) can be used alone or in combination of two or more.

For example, the aliphatic tetracarboxylic dianhydride compound includes but is not limited ethanetetracarboxylic dianhydride, butanetetracarboxylic dianhydride and the like.

Fair example, the alicyclic tetracarboxylic dianhydride compound includes but is not limited 1,2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,3-dichloro-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexane tetracarboxylic dianhydride, cis-3,7-dibutylcycloheptyl-1,5-diene-1,2,5,6-tetracarboxylic dianhydride, 2,3,5-tricarboxycyclopentylacetic dianhydride, bicyclo[2.2.2]-octa-7-ene-2,3,5,6-tetracarboxylic dianhydride and the like.

For example, the aromatic tetracarboxylic dianhydride compound includes but is not limited 3,4-dicarboxy-1,2,3,4-tetrahydronaphthalene-1-succinic acid dianhydride, pyromellitic dianhydride, 2,2′,3,3′-benzophenone tetracarboxylic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenylethane tetracarboxylic dianhydride, 3,3′,4,4′-dimethyl diphenylsilane tetracarboxylic dianhydride, 3,3′,4,4′-tetraphenylsilane tetracarboxylic dianhydride, 1,2,3,4-furan tetracarboxylic dianhydride, 2,3,3′,4′-biphenylether tetracarboxylic dianhydride, 3,3′,4,4′-biphenylether tetracarboxylic dianhydride, 4,4′-bis(3,4-dicarboxyphenoxy)diphenylsulfide dianhydride, 2,3,3′,4′-diphenylsulfide tetracarboxylic dianhydride, 3,3′,4,4′-diphenyl sulfide tetracarboxylic dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 2,2′3,3′-diphenyl tetracarboxylic dianhydride, 2,3,3′,4′-diphenyl tetracarboxylic dihydrate, 3,3′,4,4′-diphenyl tetracarboxylic dianhydate, bis(phthalic acid)phenylphosphine oxide dihydrate, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenyl phthalic acid)-4,4′-diphenylether dianhydride, bis(triphenylphthalic phenylmethane dianhydride, ethylene glycol-bis(anhydrotrimelitate), propylene glycol-bis(anhydrotrimelitate), 1,4-butanediol-bis(anhydrotrimelitate), 1,6-hexanediol-bis(anhydrotrimelitate), 1,8-octanediol-bis(anhydrotrimelitate), 2,2-bis(4-hydroxyphenyl)propane-bis(anhydrotrimelitate), 2,3,4,5-tetrahydrofurantetracarboxylic dianhydride, 1,3,3a,4,5,9b-Hexahydro-5-(tetrahydro-2,5-dioxofuran-3-yl)naphtho[1,2-c]furan-1,3-dione, 1,3,3a,4,5,9b-Hexahydro-5-methyl-5-(tetrahydro-2,5-dioxofuran-3-y naphtho[1,2-c]furan-1,3-dione, 1,3,3a,4,5,9b-Hexahydro-5-ethyl-5-(tetrahydro-2,5-dioxofuran-3yl)naphtho[1,2-c]furan-1,3-dione, 1,3,3a,4,5,9b-Hexahydro-7-methyl-5-(tetrahydro-2,5-dioxofuran-3-yl)naphtho[1,2-c]furan-1,3-dione, 1,3,3a,4,5,9b-Hexahydro-7-ethyl-5-(tetrahydro-2,5-dioxofuran-3-yl)naphtho[1,2-c]furan-1,3-dione, 1,3,3a,4,5,9b-Hexahydro-8-methyl-5-(tetrahydro-2,5-dioxofuran-3-yl)naphtho[1,2-c]furan-1,3-dione, 1,3,3a,4,5,9b-Hexahydro-8-ethyl-5-(tetrahydro-2,5-dioxofuran-3-yl)naphtho1,2-c]furan-1,3-dione, 1,3,3a,4,5,9b-Hexahydro-5-(tetrahydro-2,5-dioxofuran-3-yl)naphtho[1,2-c]furan-1,3-dione, 1,3,3a,4,5,9b-Hexahydro-5,8-dimethyl-5-(tetrahydro-2,5-dioxofuran-3-yl)naphtho[1,2-c]furan-1,3-dione, 5-(2,5-dioxotetrahydrofuran)-3-methyl-3-cyclohexene-1,2-dicarboxylic dianhydride and the like.

The other tetracarboxylic dianhydride compound (a-2) having a structure of formula (I-4) to (I-9) all of which are showed as follows:

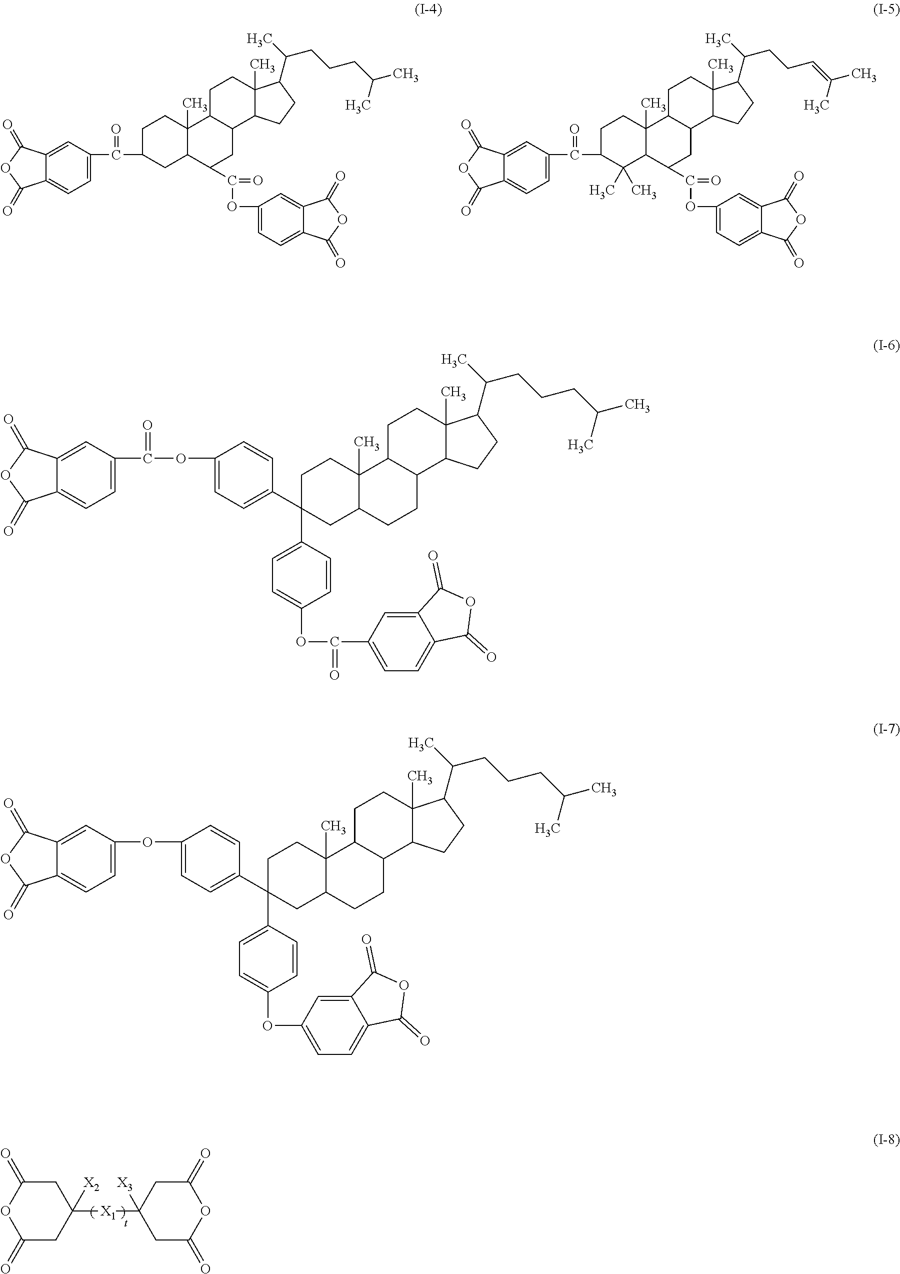

In formula (I-8) X₁ is a divalent group having an aromatic group; t is an integer of 1 or 2; X₂ and X₃ can be the same or different, and X₂ and X₃ respectively are a hydrogen atom or an alkyl group. Preferably, the other tetracarboxylic dianhydride compound (a-2) having a structure of for formula (I-8) can be selected from the group consisting of a compound having a structure of formula (I-8-1) to (I-8-3):

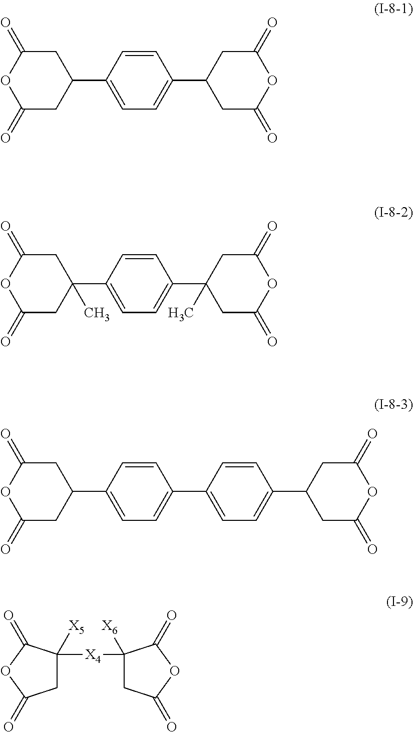

In formula (I-9), X₄ is a divalent group having an aromatic group; X₅ and X₆ can be the same or different, and X₅ and X₆ respectively are a hydrogen atom or an alkyl group. Preferably, the other tetracarboxylic dianhydride compound (a-2) having a structure of formula (I-9) can be selected from the group consisting of the compound having a structure of formula (I-9-1):

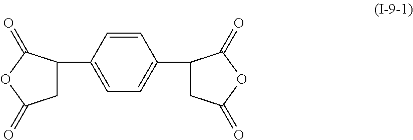 [SMILES: O=C1CC(c2ccc(C3CC(=O)OC3=O)cc2)C(=O)O1]

Preferably, the other tetracarboxylic dianhydride compound (a-2) includes but is not limited 1,2,3,4-cyclobutane tetracarboxylic dianhydride, 1,2,3,4-cyclopentane tetracarboxylic dianhydride, 2,3,5-tricarboxycyclopentane acetic acid dianhydride, 1,2,4,5-cyclohexane tetracarboxylic dianhydride, 3,4-dicarboxy-1,2,3,4-tetrahydronaphthalene-1-succinic acid dianhydride, pyromellitic dianhydride, 3,3′,4,4′-benzophenone tetracarboxylic dianhydride and 3,3′,4,4′-biphenylsulfone tetracarboxylic dianhydride.

Based on the tetracarboxylic dianhydride component (a) as 100 moles, the amount of the other tetracarboxylic dianhydride compound (a-2) is 0 mole to 80 moles, preferably is 10 moles to 70 moles, and more preferably is 20 moles to 60 moles.

### Diamine Component (b)

Diamine Compound (b-1)

The diamine component (b) includes at least one diamine compound (b-1) having a structure of formula (II-1):

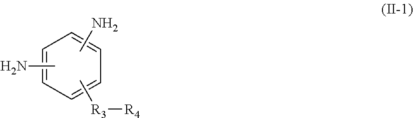

in the formula (II-1), R₃ is

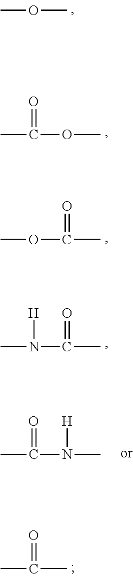

R₄ is a steroid-containing group, an alkyl group of 2 to 30 carbons or a group having a structure of formula (II-2):

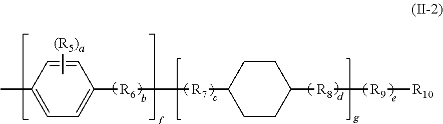

in the formula (II-2), R₅ is a hydrogen atom, a fluorine atom or a methyl group, R₆, R₇ and R₈ respectively are a single bond,

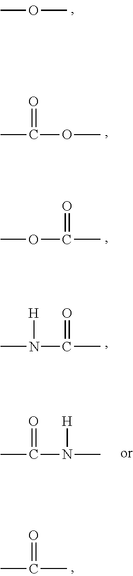

or an alkylene group of 1 to 3 carbons; R₉ is

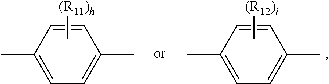

and R₁₁ and R₁₂ respectively are a hydrogen atom, a fluorine atom or a methyl group; R₁₀ is a hydrogen atom, a fluorine atom, an alkyl group of 1 to 12 carbons, a fluoroalkyl group of 1 to 12 carbons, an alkoxyl group of 1 to 12 carbons, —OCH₂F, —OCHF₂ or —OCF₃; a is 1 or 2; b, c and d respectively are an integer of 0 to 4; e, f, and g respectively are an integer of 0 to 3, and (e+f+g)≧1; h and i respectively are 1 or 2; when R₅, R₆, R₇, R₈, R₉, R₁₀, R₁₁ and R₁₂ are pluralities, R₅, R₆, R₇, R₈, R₉, R₁₀, R₁₁ and R₁₂ respectively are the same or different.

For example, the diamine compound (b-1) 2,4-diaminophenyl ethyl formate, 3,5-diaminophenyl ethyl formate, 2,4-diaminophenyl propyl formate, 3,5-diaminophenyl propyl formate, 1-dodecoxy-2,4-aminobenzene, 1-hexadecoxy-2,4-aminobenzene, 1-octadecoxy-2,4-aminobenzene and compounds having a structure of formula (II-3) to (II-31):

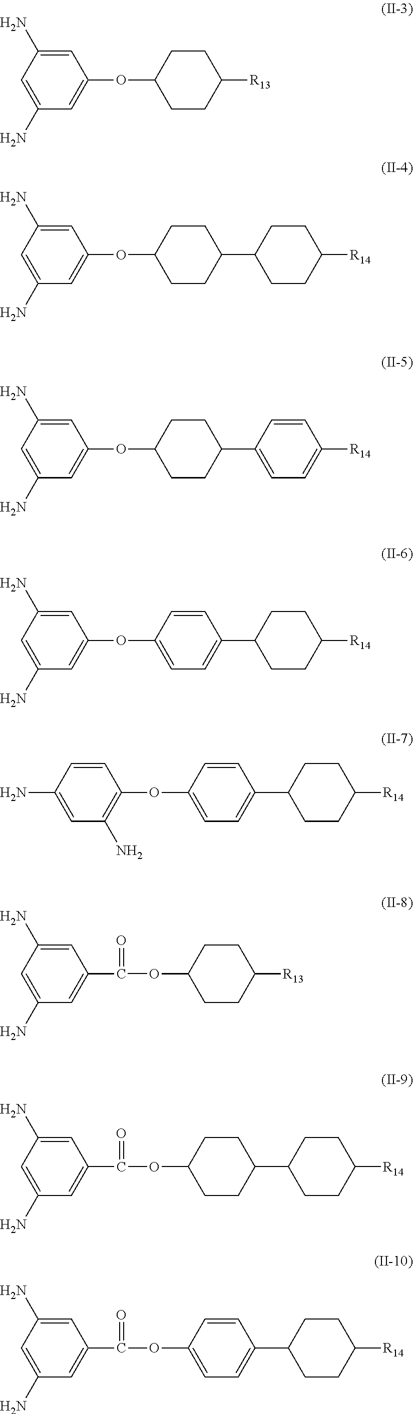

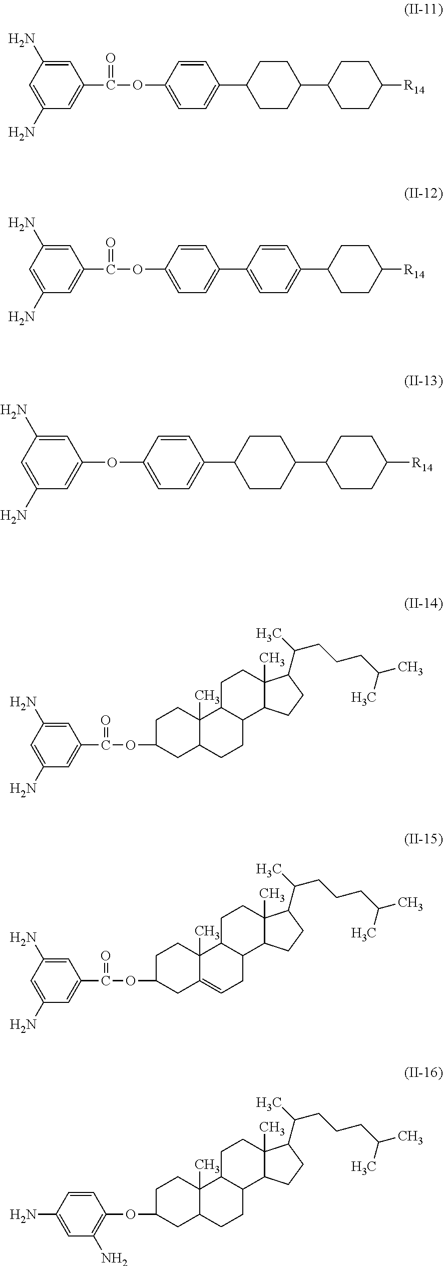

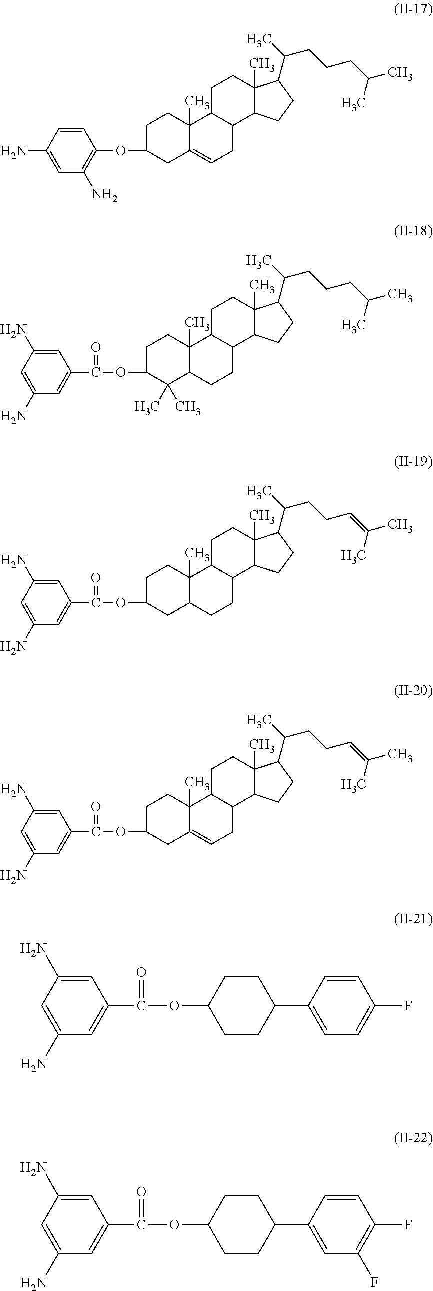 [SMILES: CC(C)CCCC(C)C1CCC2C3CC=C4CC(Oc5ccc(N)cc5N)CCC4(C)C3CCC12C ; CC(C)CCCC(C)C1CCC2C3CCC4C(C)(C)C(OC(=O)c5cc(N)cc(N)c5)CCC4(C)C3CCC12C ; CC(C)=CCCC(C)C1CCC2C3CCC4CC(OC(=O)c5cc(N)cc(N)c5)CCC4(C)C3CCC12C ; CC(C)=CCCC(C)C1CCC2C3CC=C4CC(OC(=O)c5cc(N)cc(N)c5)CCC4(C)C3CCC12C ; Nc1cc(N)cc(C(=O)OC2CCC(c3ccc(F)cc3)CC2)c1 ; Nc1cc(N)cc(C(=O)OC2CCC(c3ccc(F)c(F)c3)CC2)c1]

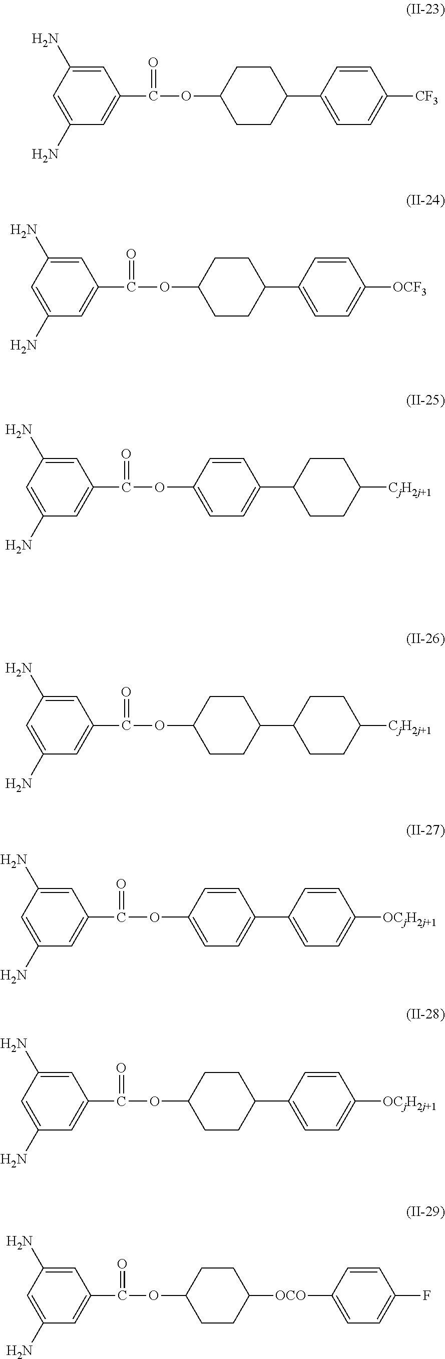

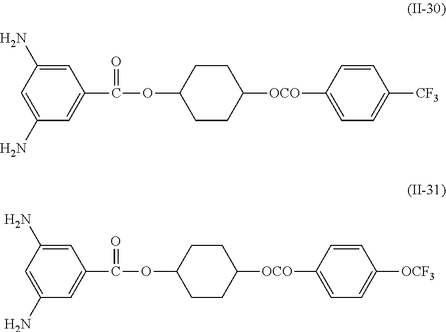

in the formula (II-3) to (II-13), R₁₃ preferably is an alkyl group of 1 to 10 carbons or an alkoxy group of 1 to 10 carbons and R₁₄ preferably is a hydrogen atom, an alkyl group of 1 to 10 carbons or an alkoxy group of 1 to 10 carbons. In the formula (II-25) to (II-28), j is an integer of 3 to 12.

The aforementioned diamine compound (b-1) can be used alone or in combination of two or more.

When the liquid crystal alignment agent comprises the aforementioned tetracarboxylic dianhydride compound (a-1) and the diamine compound (b-1), the liquid crystal alignment agent has excellent process stability and the charge accumulation can be rapidly relaxed.

Based on the diamine component (b) as 100 moles, the amount of the diamine compound (b-1) is 1 mole to 50 moles, preferably is 2 moles to 40 moles, and more preferably is 3 moles to 30 moles.

When the amount of the diamine compound (b-1) is 1 mole to 50 moles, the liquid crystal alignment agent can further improve the process stability.

Other Diamine Compound (b-2)

The diamine component (b) of the present invention can selectively combine the other diamine compound (b-2) besides the diamine compound (b-1). The other diamine compound (b-2) includes but is not limited 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxyl)ethane, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadiene diamine, tricyclo(6•2•1•0^{2,7})-undecenoyldimethyldiamine, 4,4′-methylenebis(cyclohexylamine), 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4′-aminophenyl)-1,3,3-trimethylindane, hexahydro-4,7-methanoindanylenedimethylenediamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxyl)benzene, 1,3-bis(4-aminophenoxy)benzene, 1,3-bis(3-aminophenoxyl)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylene)bisaniline, 4,4′-(m-phenylene isopropylene)bisaniline, 2,2′-bis[4-(4-amino-2-trifluoromethyl phenoxy)phenyl]hexafluoropropane, 4,4′-bis[(4-amino-2-trifluoro)phenoxy]octafluorophenylbenzene, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, and the other diamine compound (b-2) having a structure of formula (II-32) to (II-54):

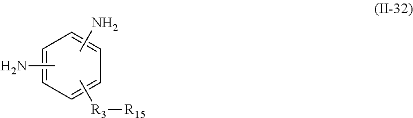

In the formula (II-32), R₃ is the same as above, and R₁₅ is a trifluoromethyl group, a fluoro atom and a monovalent nitrogen-containing cyclic group derived from pyridine, pyrimidine, triazine, piperidine, piperazine and the like.

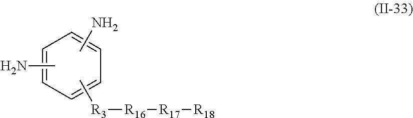

In the formula (II-33), R₃ is the same as above, R₁₆ and R₁₇ is an alicyclic group, an aromatic group or a heterocyclic group, and R₁₆ is an alkyl group of 3 to 18 carbons, an alkoxy group of 3 to 18 carbons, a fluoroalkyl group of 1 to 5 carbons, a fluoroalkoxy group of 1 to 5 carbons, a cyano group or a halogen atom,

Preferably, the other diamine compound (b-2) having a structure of formula (II-33) is selected from the group consisting of a compound having a structure of formula (II-33-1) to (II-33-5):

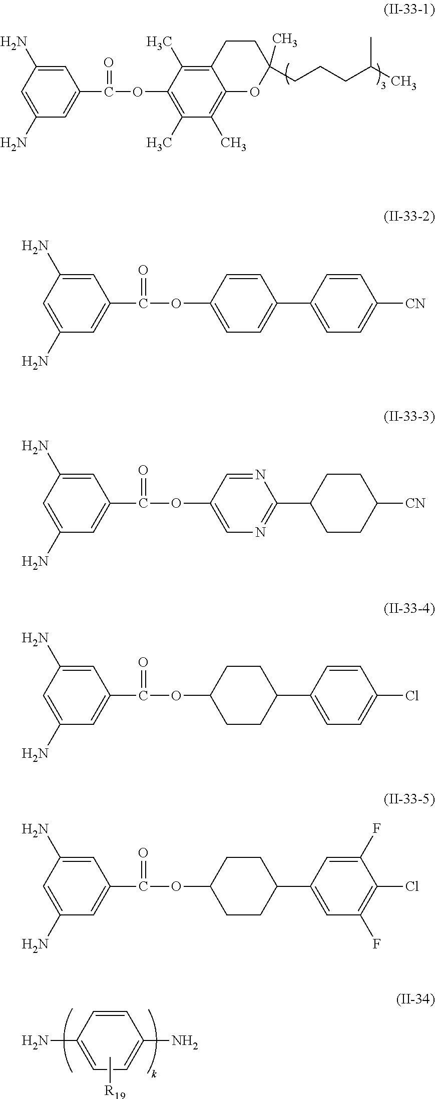

In the formula (II-34), R₁₉ is a hydrogen atom, an acyl group of 1 to 5 carbons, an alkyl group of 1 to 5 carbons, an alkoxy group of 1 to 5 carbons or a halogen atom, and R₁₉ of every repeating unit can be the same or different. The k is an integer of 1 to 3. Preferably, the other diamine compound (b-2) having a structure of formula (II-34) is selected from (1) when k is 1, such as p-diaminobenzene, m-diaminobenzene, o-diaminobenzene, 2,5-diaminotoluene and the like; (2) when k is 2, such as 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, 4,4′-diamino-2,2′-bis(trichloromethyl)biphenyl and the like; (3) when k is 3, such as 1,4-bis(4′-aminophenyl)benzene and the like. More preferably, the other diamine compound (b-2) is p-diaminobenzene, 2,5-diaminotoluene, 4,4′-diaminobiphenyl, 3,3′-dimethoxy-4,4′-diaminobiphenyl or 1,4-bis(4′-aminophenyl)benzene.

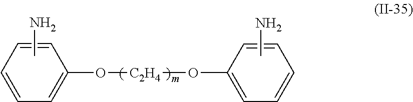

In the formula (II-35), m is an integer of 2 to 12.

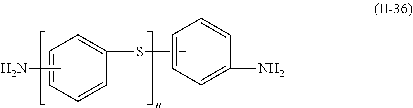

In the formula (II-36), n is an integer of 1 to 5. Preferably, formula (II-36) is selected from 4,4′-diamino-diphenylsulfide.

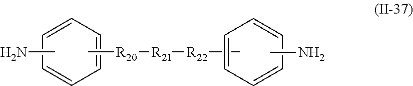

In the formula (II-37), R₂₀ and R₂₁ is the same or different, and R₂₀ and R₂₁ respectively are divalent organic groups; R₂₁ is a divalent nitrogen-containing cylic group derived from pyridine, pyrimidine, triazine, piperidine, piperazine and the like.

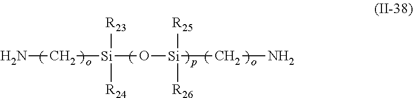

In the formula (II-38), R₂₃, R₂₄, R₂₅ and R₂₆ are the same or different, and R₂₃, R₂₄, R₂₅ and R₂₆ respectively are hydrocarbon group of 1 to 12 carbons; o is an integer of 1 to 3; p is an integer of 1 to 20.

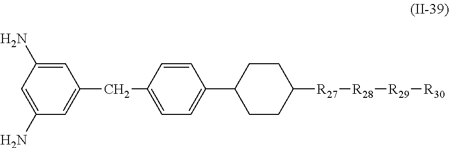

In the formula (II-39), R₂₇ is an oxygen atom or a cyclohexylene; R₂₈ is —CH₂—; R₂₉ is phenylene or cyclohexylene; R₃₀ is a hydrogen atom or a heptyl. Preferably, the other diamine compound (b-2) having a structure of formula (II-39) is selected from the group consisting of the compound having a structure of formula (II-39-1) to (II-39-2):

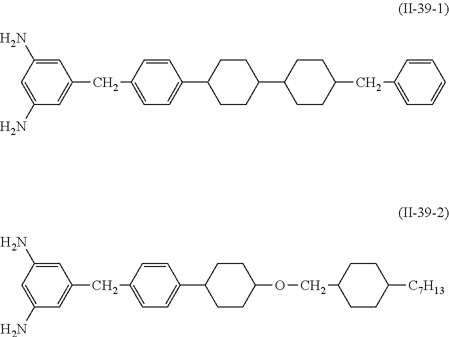

The other diamine compound (b-2) having a structure of formula (II-40) to (II-46) are showed as follows:

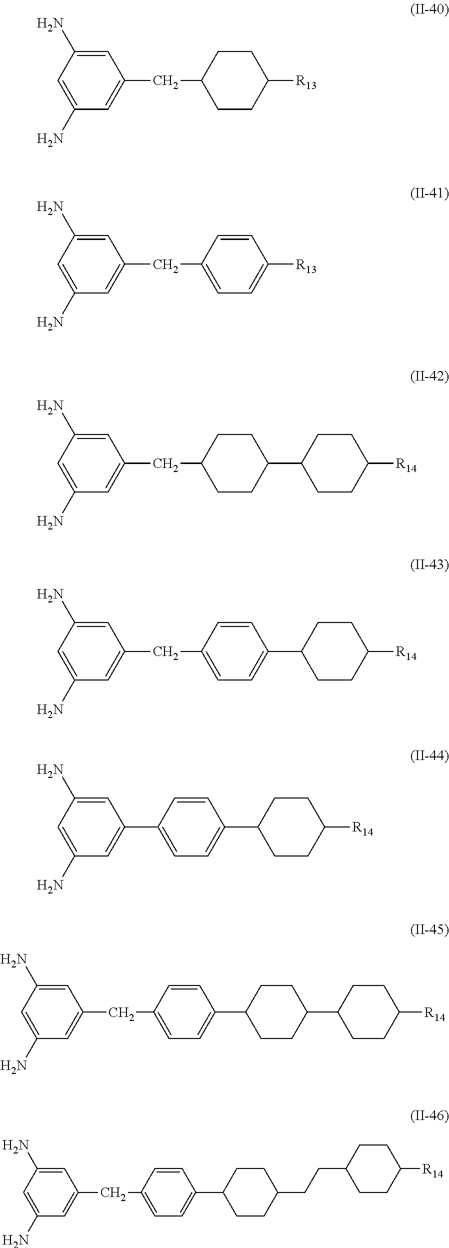

in the formula (II-40) to (II-46), R₁₃ preferably is an alkyl group of 1 to 10 carbons or an alkoxy group of 1 to 10 carbons. R₁₄ preferably is a hydrogen atom, an alkyl group of 1 to 10 carbons or an alkoxy group of 1 to 10 carbons.

The other diamine compound (b-2) having a structure of formula (II-47) to (II-54) are shown as follows:

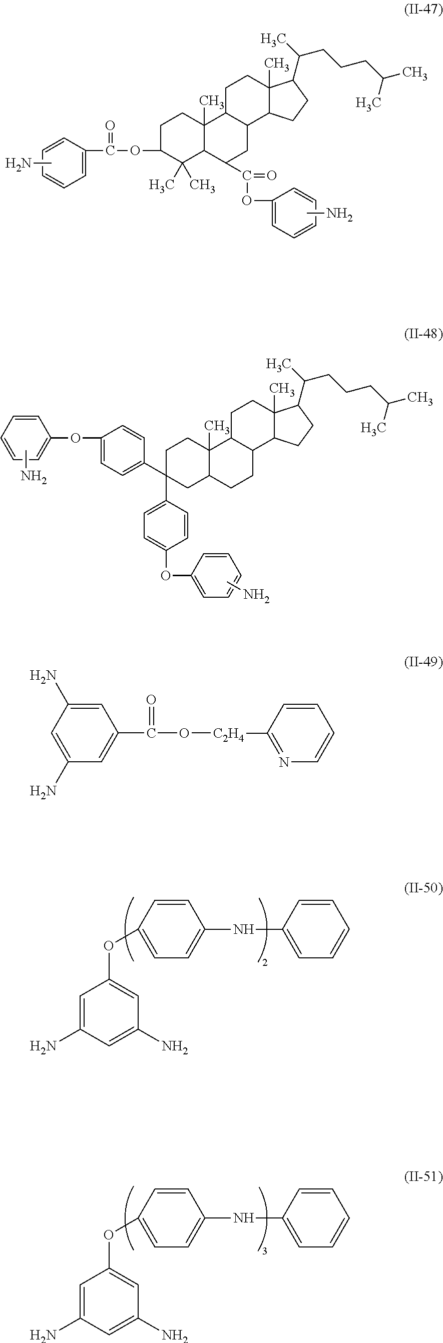

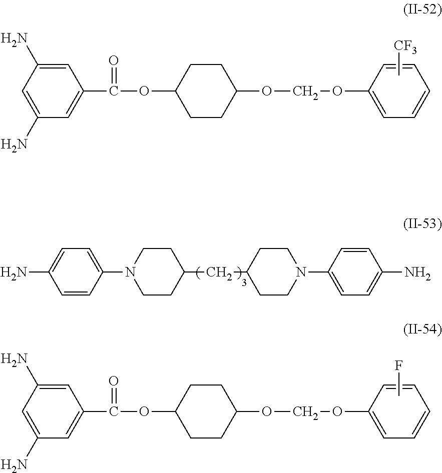

Preferably, the aforementioned other diamine compound (b-2) is 1,2-diaminoethane, 4,4′-diaminodicyclohexyl methane, 4,4′-diaminodiphenylmethane, 4,4′-diaminodiphenylether, 5-[4-(4-n-amylcyclohexyl)cyclohexyl]phenylmethylene-1,3-diaminobenzene, 1,1-bis[4-(4-aminophenoxy)phenyl]-4-(4-ethylphenyl)cyclohexane, p-diaminobenzene, m-diaminobenzene, o-diaminobenzene or a compound having a structure of formula (II-39-1).

Based on the diamine component (b) as 100 moles, the amount of the other diamine compound (b-2) is 50 moles to 99 moles, preferably is 60 moles to 98 moles, and more preferably is 70 moles to 97 moles.

### Method of Producing Polymer(A)

Method of Producing Polyamic Acid

A mixture is dissolved in a solvent, and the mixture includes a tetracarboxylic dianhydride component(a) and a diamine component (b). A polycondensation reaction is performed at 0° C. to 100° C. After 1 hour to 24 hours the aforementioned reacting solution is subjected to a reduced pressure distillation by an evaporator, or the aforementioned reacting solution was poured into a great quantity poor solvent to obtain a precipitate. Then, the precipitate is dried by a method of reduced pressure drying to produce polyamic acid.

Based on the diamine component (b) as 100 moles, the amount of the tetracarboxylic dianhydride component (a) preferably is 20 moles to 200 moles, and more preferably is 30 moles to 120 moles.

The solvent used in the polycondensation reaction can be the same as or different from the solvent in the liquid crystal alignment agent. The solvent used in the polycondensation reaction does not have any special limitations. The solvent needs to dissolve the reactant and the product. Preferably, the solvent includes but is not limited (1) aprotic solvent, such as N-methyl-2-pyrrolidinone (NMP), N,N-dimethylacetamide, N,N-dimethylformamide, dimethylsulfoxide, γ-butyrolactone, tetramethylurea, hexmethyl phosphoric acid triamide and t he like; (2) phenolic solvent, such as m-cresol, xylenol, phenol, halogenated phenol and the like. Based on the mixture as 100 parts by weight, the amount of the solvent used in the polycondensation reaction preferably is 200 to 2000 parts by weight, and more preferably is 300 to 1800 parts by weight.

Particularly, in the polycondensation reaction, the solvent can combine with suitable poor solvent. The formed polyamic acid, won't precicpitate in the poor solvent. The poor solvent can be used alone or in combination of two or more, and the poor solvent includes but is not limited (1) alcohols, such as methanol, ethanol, isopropanol, cyclohexanol, ethylene glycol, propylene glycol, 1,4-butanediol, triethyleneglycol and the like; (2) ketone, such as acetone, methyl ethyl ketone, methyl isobutyl ketone, cyclohexanone and the like; (3) ester, such as methyl acetate, ethyl acetate, butyl acetate, diethyl oxalate, diethyl malonate, ethylene glycol monoethyl ether acetate and the like; (4) ether, such as diethyl ether, ethylene glycol methyl ether, ethylene glycol ethyl ether, ethylene glycol n-propyl ether, ethylene glycol isopropyl ether, ethylene glycol n-butyl ether, ethylene glycol dimethyl ether, diethylene glycol dimethyl ether and the like; (5) halohydrocarbon, such as dichloromethane, 1,2-dichloroethane, 1,4-dichlorobutane, trichloroethane, chlorobenzene, m-dichlorobenzene and the like; (6) hydrocarbon, such as tetrahydrofuran, hexane, heptane, octane, benzene, toluene, xylene and the like, or a combination thereof. Based on the diamine component (b) as 100 parts by weight, the amount of the poor solvent preferably is 0 to 60 parts by weight, and more preferably is 0 to 50 parts by weight.

Method of Producing Polyimide

A mixture is dissolved in a solvent, and a polymerization reaction is performed to form polyamic acid. The aforementioned mixture includes a tetracarboxyl c dianhydride component (a) and a diamine component (b). Then, polyamic acid is heated to subject a dehydration ring-closure reaction in the presence of a dehydrating agent and a catalyst. The amic acid group of the polyamic acid is converted to an imide group by the dehydration ring-closure reaction, that is to say imidization, so as to form polyimide.

The solvent used in the dehydration ring-closure reaction can be the same as the solvent in the liquid crystal alignment agent and is not illustrated any more here. Based on polyamic acid as 100 parts by weight, the amount of the solvent used in the dehydration ring-closure reaction preferably is 200 to 2000 parts by weight, and more preferably is 300 to 1800 parts by weight.

The operating temperature of the dehydration ring-closure reaction preferably is 40° C. to 200° C. to get a better imidization ratio of the polyamic acid. More preferably, the aforementioned temperature is 40° C. to 150° C. When the operating temperature of the dehydration ring-closure reaction is lower than 40° C., the reaction is incomplete, thereby lowering the imidization ratio of the polyamic acid. However, when the operating temperature is higher than 200° C., the weight-average molecular weight of the polyimide is lower.

The imidization ratio of the polymer (A) is 30% to 95%, preferably is 40% to 90%, and more preferably is 50% to 85%. When the imidization ratio of the polymer (A) is 30% to 95%, the liquid crystal alignment agent can rapidly relax the charge accumulation.

The dehydrating agent used in the dehydration ring-closure reaction is selected from the group consisting of acid anhydride compound. For example, the acid anhydride compound is acetic anhydride, propionic anhydride, trifluoroacetic anhydride and the like. Based on the polyamic acid as 1 mole, the amount of the dehydrating agent is 0.01 moles to 20 moles. The catalyst used in the dehydration ring-closure reaction is selected from (1) pyridine compound, such as pyridine, trimethyl pyridine, dimethyl pyridine and the like; (2) tertiary amine compound, such as triethyl amine and the like. Based on the dehydrating agent as 1 mole, the amount of the catalyst is 0.5 moles to 10 moles.

Method of Producing Polyimide Series Block Copolymer

The polyimide series block-copolymer is selected from the group consisting of the polyamic acid block-copolymer, polyimide block-copolymer, polyamic acid-polyimide, block copolymer and a combination thereof.

Preferably, a starting material is dissolved in a solvent, and polycondensation reaction is performed to produce polyimide series block-copolymer. The starting material includes at least one aforementioned polyamic acid and/or at least one aforementioned polyimide, and the starting material further comprises a tetracarboxylic dianhydride component and diamine component.

The tetracarboxylic dianhydride component and the diamine component in the starting material are the same as the tetracarboxylic dianhydride component and the diamine component used in the method of producing aforementioned polyamic acid. The solvent used in the polycondensation reaction is the same as the solvent in the liquid crystal alignment agent and is not illustrated any more here.

Based on the starting material as 100 parts by weight, the solvent used in the polymerization reaction preferably is 200 to 2000 parts by weight, and more preferably is 300 to 1800 parts by weight. The operating temperature of the polymerization reaction preferably is 0° C. to 200° C., and more preferably is 0° C. to 100° C.

Preferably, the starting material includes but is not limited (1) two polyamic acid having different terminal groups and different structures; (2) two polyimide having different terminal groups and different structures; (3) the polyamic acid and the polyimide that have different terminal groups and different structures; (4) the polyamic acid, the tetracarboxylic dianhydride component and the diamine component, and the structure of the at least one of the tetracarboxylic dianhydride component and the diamine component is different from the structures of the tetracarboxylic dianhydride component and the diamine component that are used to form the polyamic acid; (5) the polyimide, the tetracarboxylic dianhydride component and the diamine component, and the structure of the at least one of the tetracarboxylic dianhydride component and the diamine component is different from the structures of the tetracarboxylic dianhydride component and the diamine component that are used to form the polyimide; (6) the polyamic acid, the polyimide, the tetracarboxylic dianhydride component and the diamine component, and the structure of the at least one of the tetracarboxylic dianhydride component and the diamine component is different from the structures of the tetracarboxylic dianhydride component and the diamine component that are used to form the polyamic acid or the polyimide; (7) two polyamic acid, tetracarboxylic dianhydride components or diamine components, and they have different structures; (8) two polyimide, tetracarboxylic dianhydride components or diamine components, and they have different structures; (9) two polyamic acid and a diamine component, and the two polyamic acid have different structures and the terminal groups of the polyamic acid are acetic anhydride groups; (10) two polyamic acid and a tetracarboxylic dianhydride component, and the two polyamic acid have different structures and the terminal groups of the polyamic acid are amine groups; (11) two polyimide and a diamine component, and the two polyimide have different structures and the end groups of the polyimide are acid anhydride groups; (12) two polyimide and a tetracarboxylic dianhydride component, and the two polyimide have different structures and the terminal groups of the polyimide are amine groups.

Preferably, the polyamic acid, the polyimide and the polyimide block copolymer can be terminal-modified polymer after adjusting the molecular weight without departing from the efficiency of the present invention. The terminal-modified polymer can improve a coating ability of the liquid crystal alignment agent. When the polymerization reaction of the polyamic acid is performed, a compound having a monofunctional group is added to produce the terminal-modified polymer. The monofunctional group includes but is not limited (1) monoacid anhydride, such as maleic anhydride, phthalic anhydride, itaconic anhydride, n-decyl succinic anhydride, n-dodecyl succinic anhydride, n-tetradecyl succinic anhydride, n-hexadecyl succinic anhydride and the like; (2) monoamine compound, such as aniline, cyclohexaylamine, n-butylamine n-pentylamine, n-hexylamine, n-heptylamine, n-octylamine, n-nonylamine, n-decylamine, n-undecylamine, n-dodecylamine, n-tridecylamine, n-tetradecylamine, n-pentadecylmaine, n-hexadecylamine, n-heptadecylamine, n-octadecylamine, n-eicosylamine and the like; (3) monoisocyanate compound, such as phenylisocyanate, naphthylisocyanate and the like.

### Solvent (B)

Preferably, the solvent (B) is N-methyl-2-pyrrolidone, γ-butyrolactone, γ-butyrolactam, 4-hydroxyl-4-methyl-2-pentanone, ethylene glycol monomethyl ether, butyl lactate, butyl acetate, methylmethoxypropionate, ethylethoxypropionate, ethylene glycol methyl ether, ethylene glycol ethyl ether, ethylene glycol n-propyl ether,ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether aceatte, diglycol monoethyl ether aceate, N,N-dimethylformamide, N,N-dimethylethanamide and the like. The solvent (B) can be used alone or in combination of two or more.

### Additive (C)

The liquid crystal alignment agent can selectively includes an additive (C) without departing from the efficiency of the present invention. The additive (C) is an epoxy compound or a functional group-containing silane compound. The additive (C) can enhance the adhesion between the liquid crystal alignment film and the surface of the substrate. The additive (C) can be used alone or in combination of two or more.

The epoxy compound includes but is not limited ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, 2,2-dibromo-neopentyl diglycidyl ether, 1,3,5,6-tetraglycidyl-2,4-hexanediol, N,N,N′,N′-tetraglycidyl-m-xylene diamine, 1,3-bis(N,N-diglycidylaminomethyl)cyclohexane, N,N,N′,N′-tetraglycidyl-4,4′-diaminodiphenylmethane, N,N-glycidyl-p-glycidoxy aniline, 3-(N-allyl-N-glycidyl)aminopropyltrimethoxyl silane, 3-(N,N-diglycidyl)aminopropyltrimethoxyl silane and the like.

The functional group-containing silane compound includes but is not limited to 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetrimine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, N-bis(oxyethylene)-3-aminopropyltriethoxysilane and the like.

### Producing Liquid Crystal Alignment Agent

The liquid crystal alignment agent of the present invention is produced by a conventional mixing method. For example, the tetracarboxylic dianhydride component (a) and the diamine component (b) are mixed uniformly to produce the polymer (A). Then, the polymer (A) is added to the solvent (B) at 0° C. to 200° C. in a mixer until all composition are mixed uniformly, and the additive (C) is selectively added. Preferably, the solvent is added into the polymer composition at 20° C. to 60° C.

Preferably, at 25° C., a viscosity of the liquid crystal alignment agent is 15 cps to 35 cps, preferably is 17 cps to 33 cps, and more preferably is 20 cps to 30 cps.

### Producing Liquid Crystal Alignment Film

The producing method of the liquid crystal alignment film comprises the following steps. The aforementioned liquid crystal alignment agent firstly is coated on a surface of a substrate to form a coating film by a roller coating, a spin coating, a printing coating, an ink-jet printing and the like. Then, a pre-bake treatment, a post-bake treatment and an alignment treatment are subject to the coating film to produce the liquid crystal alignment film.

An organic solvent in the coating film is volatilized by the aforementioned pre-bake treatment. The operating temperature of the pre-bake treatment is 30° C. to 120° C., preferably is 40° C. to 110° C., and more preferably is 50° C. to 100° C.

The alignment treatment does not have any limitations. The liquid crystal alignment film is rubbed along a desired direction with a roller that is covered with a cloth made from fibers such as nylon, rayon, and cotton like. The aforementioned alignment treatment is widely known rather than focusing or mentioning them in details.

The polymer in the coating film is further subjected to the dehydration ring-closure (imidization) reaction by the post-bake treatment. The operating temperature of the post-bake treatment is 150° C. to 300° C., preferably is 180° C. to 280° C., and more preferably is 200° C. to 250° C.

### Producing Method of Liquid Crystal Display Element

The producing method of the liquid crystal display element is widely known rather than focusing or mentioning them in details.

Reference is made to FIG. 1, which is a cross-sectional diagram of a liquid crystal display element according to the present invention. In a preferable example, the liquid crystal element 100 includes a first unit 110, a second unit 120 and a liquid crystal 130. The second unit 120 is spaced apart opposite the first unit 110, and the liquid crystal 130 is disposed between the first unit 110 and the second unit 120.

The first unit 110 includes a first substrate 111, a first conductive film 113 and a first liquid crystal alignment film 115. The first conductive film 113 is disposed on a surface of the first substrate 111, and the first liquid crystal alignment film 115 is disposed on a surface of the first conductive film 113.

The second unit 120 includes a second substrate 121, a second conductive film 123 and a second liquid crystal alignment film 125. The second conductive film 123 is disposed on a surface of the second substrate 121, and the second liquid crystal alignment film 125 is disposed on a surface of the second conductive film 123.

The first substrate 111 and the second substrate 121 are selected from a transparent material and the like. The transparent material includes but is not limited an alkali-free glass, a soda-lime glass, a hard glass (Pyrex glass), a quartz glass, polyethylene terephthalate, polybutylene terephthalate, polyethersulfone, polycarbonate and the like. The materials of the first conductive film 113 and the second conductive film 123 are selected from tin oxide (SnO₂), indium oxide-tin oxide (In₂O₃—SnO₂) and the like.

The first liquid crystal alignment film 115 and the second liquid crystal alignment film 125 respectively are the aforementioned liquid crystal alignment films, which can provide the liquid crystal 130 with a pretilt angle. The liquid crystal 130 is driven by an electric field induced by the first conductive film 113 and the second conductive film 123.

A liquid crystal material used in the liquid crystal 130 can be used alone or in combination of two or more. The liquid crystal material includes but is not limited 1,4-diaminobenzene liquid crystal, pyridazine liquid crystal, Shiff Base liquid crystal, azoxy liquid crystal, biphenyl liquid crystal, phenylcyclohexane liquid crystal, ester liquid crystal, terphenyl liquid crystal, biphenyl cyclohexane liquid crystal, pyrimidine liquid crystal, dioxane liquid crystal, bicyclooctane liquid crystal, cubane liquid crystal and the like. Optionally, the liquid crystal material includes cholesterol liquid crystal, such as cholesteryl chloride, cholesteryl nonanoate, cholesteryl carbonate and the like; chiral agent, such as products made by Merck Co. Ltd., and the trade name are C-15 and CB-15; ferroelectric liquid crystal, such as p-decoxylbenzilidene-p-amino-2-methyl butyl cinnamate and the like.

Several embodiments are described below to illustrate the application of the present invention. However, these embodiments are not used for limiting the present invention. For those skilled in the art of the present invention, various variations and modifications can be made without departing from the spirit and scope of the present invention.

### BRIEF DESCRIPTION OF THE DRAWINGS

The invention can be more fully understood by reading the following detailed description of the embodiment, with reference made to the accompanying drawings as follows:

FIG. 1 is a cross-sectional diagram of a liquid crystal display element according to the present invention.

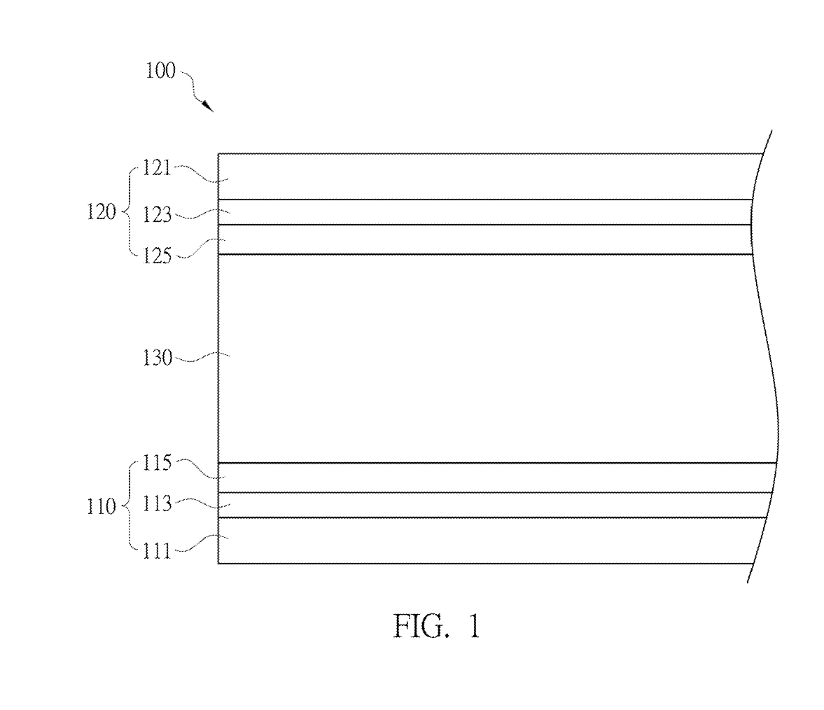

### DETAILED DESCRIPTION

### Producing Polymer (A)

Hereinafter, the polymer (A) of Synthesis Examples A-1-1 to A-2-10 and Comparative Synthesis Examples A-3-1 to A-3-6 were according to Table 1 and Table 2 as follows.

### SYNTHESIS EXAMPLE A-1-1

A 500 ml four-necked conical flask equipped with a nitrogen inlet, a stirrer, a condenser and a thermometer was purged with nitrogen. Then, 0.188 g (0.0005 mole) of the 1-octadecoxy-2,4-aminobenzene (hereinafter abbreviated as b-1-1), 9.83 g (0.0495 mole) of 4,4′-diaminodiphenylmethane (hereinafter abbreviated as b-2-1), and 80 g of N-methyl-2-pyrrolidinone (hereinafter abbreviated as NMP) were added. Next, 26.8 g (0.04 mole) of 9,9-bis[4-(3,4-dicarboxyphenoxyl)-2-methylphenyl]fluorene dianhydride (hereinafter abbreviated as a-1-1), 2.18 g (0.01 mole) of pyromellitic anhydride (hereinafter abbreviated as a-2-1) and 20 g of NMP were added and left to react for 2 hours at room temperature. After the reaction was completed, the reacting solution was poured into 1500 ml of water to precipitate a polymer. The polymer obtained after filtering was repeatedly washed using methanol and filtered thrice, and then placed into a vacuum oven, where drying was carried out at 60° C., thereby obtaining a polyamic acid (A-1-1). An imidization ratio of the resulted polyamic acid (A-1-1) was evaluated according to the following evaluation method, and the result thereof was listed as Table 1. The evaluation method of the imidization ratio was described as follows.

### SYNTHESIS EXAMPLE A-1-2 TO A-1-5 AND COMPARATIVE EXAMPLES A-3-5 AND A-3-6

Synthesis Examples A-1-2 to A-1-5 and Comparative Examples A-3-5 and A-3-6 were practiced with the same method as in Synthesis Example A-1-1 by using various kinds or amounts of the components for the polyamic acid. The formulations and detection results thereof were listed in Table 1 and Table 2 rather than focusing or mentioning them in details.

### SYNTHESIS EXAMPLE A-2-1

A 500 ml four-necked conical flask equipped with a nitrogen inlet, a stirrer, a heater, a condenser and a thermometer was purged with nitrogen. Then, 0.188 g (0.0005 mole) of b-1-1, 9.83 g (0.0495 mole) of b-2-1 and 80 g of NMP were added. Next, 26.8 g (0.04 mole) of a-1-1, 2.18 g (0.01 mole) of a-2-1 and 20 g of NMP were added and left to react for 6 hours at room temperature. And then, 97 g of NMP, 2.55 g of acetic anhydride and 19.75 g of pyridine were added at 60° C. and left to stir for 2 hours for imidization reaction. After the reaction was complete, the reacting solution was pored into 1500 ml of water to precipitate a polymer. The polymer obtained after filtering was repeatedly washed using methanol and filtered thrice, and then placed into a vacuum oven, where drying was carried out at 60° C., thereby obtaining a polyimide (A-2-1). An imidization ratio of the resulted polyimide (A-2-1) was evaluated according to the following evaluation method, and the result thereof was listed as Table 1. The evaluation method of the imidization ratio was described as follows.

### SYNTHESIS EXAMPLE A-2-2 TO A-2-10 AND COMPARATIVE EXAMPLES A-3-1 TO A-3-4

Synthesis Examples A-2-2 to A-2-10 and Comparative Examples A-3-1 to A-3-4 were practiced with the same method as in Synthesis Example A-2-1 by using various kinds or amounts of the components for the polyimide. The formulations and detection results thereof were listed in Table 1 and Table 2 rather than focusing or mentioning them in details.

### Producing Liquid Crystal Alignment Agent, Liquid Crystal Alignment Film and Liquid Crystal Display Element

Hereinafter, the liquid crystal alignment agent, a liquid crystal alignment film and a liquid crystal display element of Examples 1 to 15 and Comparative Examples 1 to 5 were according to Table 3 and Table 4 as follows.

### EXAMPLE 1

100 parts by weight of the polymer (A-1-1) was added into 1200 parts by weight of N-methyl-2-pyrrolidinone (hereinafter abbreviated as B-1) and 600 parts by weight of ethylene glycol n-butyl ether (hereinafter abbreviated as B-2) for mixing in a mixer until all compounds were mixed uniformly at room temperature, thereby obtaining the liquid crystal alignment agent.

Then, the liquid crystal alignment agent was coated on two glass substrates by a printer (made by Nissha Printing Co. Ltd. and the trade name is S15-036) to form a coating film, and the two glass substrates both have a conductive film made by ITO (indium-tin-oxide). Then, the coating film was disposed on a heating plate, and a pre-bake was performed at 100° C. for 5 minutes. The coating film was placed into a circulation oven, and a post-bake was performed at 220° C. for 30 minutes. And then, the coating film was subjected to an alignment treatment, thereby obtaining the liquid crystal alignment films on the glass substrates.

A thermo-compression adhesive was coated on one of the aforementioned two glass substrates having the liquid crystal alignment films, and spacers of 4 μm were sprayed on the other glass substrate. Next, two glass substrates were adheredin a vertical direction. The aforementioned two glass substrates was thermo-compression adhered by a thermo-compression machine with 10 kg of pressure at 150° C. Then, a liquid crystal was injected by a liquid crystal injector (made by Shimadzu Corporation and the trade name is ALIS-100X-CH). The liquid crystal injecting inlet was sealed by an ultra violet curable adhesive, and the ultra violet curable adhesive was radiated with an ultra violet light for curing the ultra violet adhesive. And then, a liquid crystal annealing treatment was performed at 60° C. in an oven for 30 minutes, thereby obtaining the liquid crystal display element of Example 1.

The result liquid crystal alignment agent and liquid crystal display element were respectively evaluated according to the following evaluation methods, and the results thereof were listed as Table 3. The evaluation methods of the process stability and the charge accumulation were described as follows.

### EXAMPLES 2 TO 15 AND COMPARATIVE EXAMPLES 1 TO 5

Examples 2 to 15 and Comparative Examples 1 to 5 were practiced with the same method as in Example 1 by using various kinds or amounts of the components for the liquid crystal alignment agent. The formulations and detection results thereof were listed in Table 3 and Table 4 rather than focusing or mentioning them in details.

### Evaluation Methods

### 1. Imidization Ratio

The imidization ratio refers to a ratio of the number of imide ring in the total amount of the number of amic acid functional group and the number of imide ring, and the imidization ratio is presented by percentage.

After the aforementioned method of reduced pressure drying is performed, the polymer of Synthesis Examples A-1-1 to A-2-10 and Comparative Synthesis Examples A-3-1 to A-3-6 respectively were dissolved in a suitable deuteration solvent, such as dimethylsulfoxide. ¹H-NMR (hydrogen-nuclear magnetic resonance) was detected at room temperature (25° C.) using tetrametylsilane as a standard, and the imidization ratio (%) was calculated according to the following formula (III):

$$Imidization Ratio ( \% ) = [ 1 - \frac{Δ1}{Δ 2 \times α} ] \times 100 \% \qquad ( III )$$

in the formula (III), Δ1 is the peak area of the chemical shift induced by the proton of NH group near 10 ppm, Δ2 is the peak area of other proton, and α is the ratio of one proton of NH group corresponding to the number of other proton in the polyamic acid precursor.

### 2. Process Stability

The liquid crystal display elements were respectively made by the liquid crystal alignment agents of the aforementioned Examples 1 to 15 and the Comparative Examples 1 to 5. In the process for producing the liquid crystal display elements, the liquid crystal display element was subjected to a pre-bake treatment with 80° C., 90° C., 100° C., 110° C. and 120° C., thereby obtaining five liquid crystal display elements. And then a pretilt angle uniformity (P) was detected. The variation of the pretilt angle uniformity (P) was calculated according to the following formula (IV), and an evaluation was made according to the following criterion:

the variation of P=(Pₘₐₓ−Pₘᵢₙ)×100% (IV)

\textcircled{◯}: the variation of P≦2%

◯: the variation of P≦5%

Δ: 5%<the variation of P≦10%

×: 10%<the variation of P

### 3. Charge Accumulation

The liquid crystal display elements of Examples 1 to 15 and Comparative Examples 1 to 5 were respectively applied 3 voltage of direct current for 30 minutes. Then, the charge accumulation (V_{R1}) after the voltage was removed and the charge accumulation (VR2) after the voltage was removed for 15 minutes were respectively detected by an electrical measuring machine (manufactured by TOYO Corporation, Model 6254). The relaxation slope (Vₛ) of the charge accumulation was calculated according to the following formula (V), and the evaluation was made according to the following criterion:

$${V}_{s} = \frac{{V}_{{R}_{1}} - {V}_{{R}_{2}}}{{V}_{{R}_{s}}} \times 100 \% \qquad ( V )$$

\textcircled{◯}: 70%<Vₛ

◯: 65%<Vₛ≦70%

Δ: 60%<Vₛ≦65%

×: Vₛ≦60%

According to Table 3 and Table 4, when the liquid crystal alignment agent comprises the tetracarboxylic dianhydride compound (a-1) and the diamine compounds (b-1), the liquid crystal alignment agent has excellent process stability and the charge accumulation can be rapidly relaxed.

Moreover, based on the tetracarboxylic dianhydride component (a) as 100 moles, when the amount of the tetracarboxylic dianhydride compound (a-1) is 20 moles to 100 moles, the liquid crystal alignment agent has a better process stability. Based on the diamine component (b) as 100 moles, when the amount of the diamine compound (b-1) is 1 mole to 50 moles, the liquid crystal alignment agent has a better process stability.

In addition, when the imidization ratio of the polymer (A) is 30% to 95%, the liquid crystal alignment agent can rapidly relax the charge accumulation.

It should be supplemented that, although specific compounds, components, specific reactive conditions, specific processes, specific evaluation methods or specific equipments are employed as exemplary embodiments of the present invention, for illustrating the liquid crystal alignment agent, the liquid crystal alignment film and the liquid crystal display element having thereof of the present invention. However, as is understood by a person skilled in the art instead of limiting to the aforementioned examples, the liquid crystal alignment agent, the liquid crystal alignment film and the liquid crystal display element having thereof of the present invention also can be manufactured by using other compounds, components, reactive conditions, processes, analysis methods and equipment without departing from the spirit and scope of the present invention.

As is understood by a person skilled in the art, the foregoing preferred embodiments of the present invention are illustrated of the present invention rather than limiting of the present invention. In view of the foregoing, it is intended to cover various modifications and similar arrangements included within the spirit and scope of the appended claims. Therefore, the scope of which should be accorded the broadest interpretation so as to encompass all such modifications and similar structure.

TABLE 1

| | | | Synthesis Example | | | | | | | | | | | | | | |
|---|---|---|---|---|---|---|---|---|---|---|---|---|---|---|---|---|---|
| Components (mole %) | | | A-1-1 | A-1-2 | A-1-3 | A-1-4 | A-1-5 | A-2-1 | A-2-2 | A-2-3 | A-2-4 | A-2-5 | A-2-6 | A-2-7 | A-2-8 | A-2-9 | A-2-10 |
| Tetracarboxylic | Tetracarboxylic | a-1-1 | 80 | | | 20 | | 80 | | | 20 | | | | | 30 | |
| Dianhydride | Dianhydride | a-1-2 | | 50 | | | 10 | | 50 | | | 10 | | 30 | | | 90 |
| Component (a) | Compound | a-1-3 | | | 100 | | | | | 100 | | | 5 | 30 | 70 | | |
| | (a-1) | | | | | | | | | | | | | | | | |
| | Other | a-2-1 | 20 | | | 80 | | 20 | | | 80 | | | | | 70 | 5 |
| | Tetracarboxylic | a-2-2 | | 30 | | | | | 30 | | | | | | 20 | | 5 |
| | Dianhydride | a-2-3 | | 20 | | | 90 | | 20 | | | 90 | 30 | 40 | | | |
| | Compound | a-2-4 | | | | | | | | | | | 65 | | 10 | | |
| | (a-2) | | | | | | | | | | | | | | | | |
| Diamine | Diamine | b-1-1 | 1 | | | 30 | | 1 | | | 30 | | | | | | |
| Component (b) | Compound | b-1-2 | | 10 | | | 0.5 | | 10 | | | 0.5 | | 20 | | 35 | |
| | (b-1) | b-1-3 | | | 50 | | | | | 50 | | | 3 | | 40 | 20 | |
| | | b-1-4 | | | | | | | | | | | 3 | | | | 3 |
| | Other Diamine | b-2-1 | 99 | | 50 | | 60 | 99 | | 50 | | 60 | | 75 | | 45 | |
| | Compound | b-2-2 | | 90 | | | 39.5 | | 90 | | | 39.5 | | | 60 | | 20 |
| | (b-2) | b-2-3 | | | | 70 | | | | | 70 | | 95 | 5 | | | 77 |
| | | b-2-4 | | | | | | | | | | | | | | | |

| | | | | | | | | | | | | | | | |
|---|---|---|---|---|---|---|---|---|---|---|---|---|---|---|---|
| Imidization Ratio (%) | 0 | 0 | 0 | 0 | 0 | 15 | 20 | 26 | 30 | 42 | 55 | 73 | 88 | 95 | 98 |

a-1-1 9,9-bis[4-(3,4-dicarboxyphenoxy)-2-methylphenyl]fluorene dianhydride
a-1-2 tetracarboxylic dianhydride compound having a structure of formula (I-1)
a-1-3 tetracarboxylic dianhydride compound having a structure of formula (I-2)
a-2-1 pyromellitic dianhydride
a-2-2 1,2,3,4-cyclobutane tetracarboxylic dianhydride
a-2-3 butanetetracarboxylic dianhydride
a-2-4 1,2,4,5-cyclohexane tetracarboxylic dianhydride
b-1-1 1-octadecoxy-2,4-aminobenzene
b-1-2 diamine compound having a structure of formula (II-15)
b-1-3 diamine compound having a structure of formula (II-23)
b-1-4 diamine compound having a structure of formula (II-11), and R₁₄ is n-pentyl
b-2-1 4,4′-diaminodiphenylmethane
b-2-2 4,4′-diaminodiphenylether
b-2-3 p-diaminobenzene
b-2-4 9,9-bis(4-aminophenyl)fluorene

TABLE 2

| | | | Comparative Synthesis Example | | | | | |
|---|---|---|---|---|---|---|---|---|
| Components (mole %) | | | A-1-1 | A-1-2 | A-1-3 | A-1-4 | A-1-5 | A-1-6 |
| Tetracarboxylic | Tetracarboxylic | a-1-1 | 80 | | | | | |
| Dianhydride | Dianhydride | a-1-2 | | | | | | |
| Component (a) | Compound | a-1-3 | | | | | | |
| | (a-1) | | | | | | | |
| | Other | a-2-1 | 20 | | 80 | 60 | 20 | 100 |
| | Tetracarboxylic | a-2-2 | | 100 | 20 | | 40 | |
| | Dianhydride | a-2-3 | | | | 40 | 20 | |
| | Compound | a-2-4 | | | | | 20 | |
| | (a-2) | | | | | | | |
| Diamine | Diamine | b-1-1 | | | | | | |
| Component (b) | Compound | b-1-2 | | | | 20 | | |
| | (b-1) | b-1-3 | | 50 | | | | |
| | | b-1-4 | | | | | | 20 |
| | Other Diamine | b-2-1 | 99 | 50 | 30 | | 100 | 80 |
| | Compound | b-2-2 | 1 | | | | | |
| | (b-2) | b-2-3 | | | 70 | | | |
| | | b-2-4 | | | | 80 | | |

| | | | | | | |
|---|---|---|---|---|---|---|
| imidization Ratio (%) | 15 | 26 | 30 | 73 | 0 | 0 |

a-1-1 9,9-bis[4-(3,4-dicarboxyphenoxy)-2-methylphenyl]fluorene dianhydride
a-1-2 tetracarboxylic dianhydride compound having a structure of formula (I-1)
a-1-3 tetracarboxylic dianhydride compound having a structure of formula (I-2)
a-2-1 pyromellitic dianhydride
a-2-2 1,2,3,4-cyclobutane tetracarboxylic dianhydride
a-2-3 butanetetracarboxylic dianhydride
a-2-4 1,2,4,5-cyclohexane tetracarboxylic dianhydride
b-1-1 1-octadecoxy-2,4-aminobenzene
b-1-2 diamine compound having a structure of formula (II-15)
b-1-3 diamine compound having a structure of formula (II-23)
b-1-4 diamine compound having a structure of formula (II-11), and R₁₄ is n-pentyl
b-2-1 4,4′-diaminodiphenylmethane
b-2-2 4,4′-diaminodiphenylether
b-2-3 p-diaminobenzene
b-2-4 9,9-bis(4-aminophenyl)fluorene

TABLE 3

| | | Example | | | | | | | | | | | | | | |
|---|---|---|---|---|---|---|---|---|---|---|---|---|---|---|---|---|
| Composition (Parts by Weight) | | 1 | 2 | 3 | 4 | 5 | 6 | 7 | 8 | 9 | 10 | 11 | 12 | 13 | 14 | 15 |
| Polymer (A) | A-1-1 | 100 | | | | | | | | | | | | | | |
| | A-1-2 | | 100 | | | | | | | | | | | | | |
| | A-1-3 | | | 100 | | | | | | | | | | | | |
| | A-1-4 | | | | 100 | | | | | | | | | | | |
| | A-1-5 | | | | | 100 | | | | | | | | | | |
| | A-2-1 | | | | | | 100 | | | | | | | | | |
| | A-2-2 | | | | | | | 100 | | | | | | | | |
| | A-2-3 | | | | | | | | 100 | | | | | | | |
| | A-2-4 | | | | | | | | | 100 | | | | | | |
| | A-2-5 | | | | | | | | | | 100 | | | | | |
| | A-2-6 | | | | | | | | | | | 100 | | | | |
| | A-2-7 | | | | | | | | | | | | 100 | | | |
| | A-2-8 | | | | | | | | | | | | | 100 | 50 | |
| | A-2-9 | | | | | | | | | | | | | | 50 | |
| | A-2-10 | | | | | | | | | | | | | | | 100 |
| | A-3-1 | | | | | | | | | | | | | | | |
| | A-3-2 | | | | | | | | | | | | | | | |
| | A-3-3 | | | | | | | | | | | | | | | |
| | A-3-4 | | | | | | | | | | | | | | | |
| | A-3-5 | | | | | | | | | | | | | | | |
| | A-3-6 | | | | | | | | | | | | | | | |
| Solvent (B) | B-1 | 1200 | | 800 | | | 1000 | 900 | 850 | 1400 | | | 800 | 400 | | 1200 |
| | B-2 | 600 | 16000 | | 800 | 1500 | | 300 | 850 | | 1000 | | 750 | 400 | 1200 | 600 |
| | B-3 | | | 1000 | 800 | 100 | 600 | 300 | | | 350 | 1500 | | 400 | 250 | |
| Additive (C) | C-1 | | | | | | | | | 5 | | | 3 | | | |
| | C-2 | | | | | 10 | | | | | | | 3 | | | 2 |
| Evaluation | Process Stability | ⊚ | ⊚ | ⊚ | ⊚ | ◯ | ⊚ | ⊚ | ⊚ | ⊚ | ◯ | ⊚ | ⊚ | ⊚ | ⊚ | ⊚ |
| Method | Charge Accumulation | ◯ | ◯ | ◯ | ◯ | ◯ | ◯ | ◯ | ◯ | ⊚ | ⊚ | ⊚ | ⊚ | ⊚ | ⊚ | ◯ |

B-1 N-methyl-2-pyrrolidinone.
B-2 ethylene glycol n-butyl ether.
B-3 N,N-dimethylacetamide
C-1 N,N,N′,N′-tetraglycidyl-4,4′-diaminodiphenylmethane
C-2 N,N-glycidyl-p-glycidoxy aniline

TABLE 4

| | | Comparative Example | | | | |
|---|---|---|---|---|---|---|
| Composition (Parts by Weight) | | 1 | 2 | 3 | 4 | 5 |
| Polymer (A) | A-1-1 | | | | | |
| | A-1-2 | | | | | |
| | A-1-3 | | | | | |
| | A-1-4 | | | | | |
| | A-1-5 | | | | | |
| | A-2-1 | | | | | |
| | A-2-2 | | | | | |
| | A-2-3 | | | | | |
| | A-2-4 | | | | | |
| | A-2-5 | | | | | |
| | A-2-6 | | | | | |
| | A-2-7 | | | | | |
| | A-2-8 | | | | | |
| | A-2-9 | | | | | |
| | A-2-10 | | | | | |
| | A-3-1 | 100 | | | | |
| | A-3-2 | | 100 | | | |
| | A-3-3 | | | 100 | | |
| | A-3-4 | | | | 100 | |
| | A-3-5 | | | | | 90 |
| | A-3-6 | | | | | 10 |
| Solvent (B) | B-1 | 1200 | | 800 | | 850 |
| | B-2 | 600 | 16000 | | 800 | 850 |
| | B-3 | | | 1000 | 800 | |
| Additive (C) | C-1 | | | | | |
| | C-2 | | | | | |
| Evaluation | Process Stability | X | X | X | X | X |
| Method | Charge | X | X | X | X | X |
| | Accumulation | | | | | |

B-1 N-methyl-2-pyrrolidinone.
B-2 ethylene glycol n-butyl ether.
B-3 N,N-dimethylacetamide
C-1 N,N,N′,N′-tetraglycidyl-4,4′-diamino diphenyl methane
C-2 N,N-glycidyl-p-glycidoxy aniline

What is claimed is:

1. A liquid crystal alignment agent, comprising:
a polymer (A), obtained by reacting a mixture that includes a tetracarboxylic dianhydride component (a) and a diamine component (b); and
a solvent (B); and
wherein the tetracarboxylic dianhydride component (a) includes at least one tetracarboxylic dianhydride compound (a-1) having a group consisting of a structure of the formula (I-1) to (I-3), and the diamine component (b) includes at least one diamine compound (b-1) having a structure of formula (II-1): 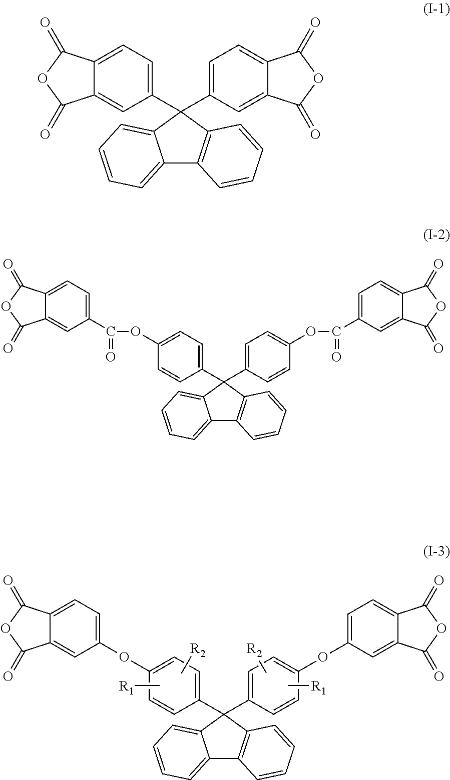
in the formula (I-3), R₁ is a hydrogen atom, an alkyl group of 1 to 6 carbons or an aryl group having a single-ring or a condensed poly-ring of 6 to 14 carbons, and R₂ is a hydrogen atom, an alkyl group of 1 to 6 carbons, or an aryl group having a single-ring or a condensed poly-ring of 6 to 14 carbons; 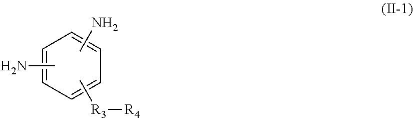
in the formula (II-1), R₃ is 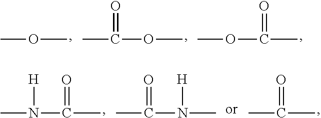
and R₄ is a steroid-containing group, an alkyl group of 2 to 30 carbons or a group having a structure of formula (II-2): 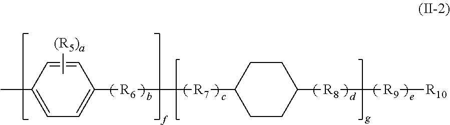
in the formula (II-2), R₅ is a hydrogen atom, a fluorine atom or a methyl group, R₆, R₇ and R₈ respectively are a single bond, 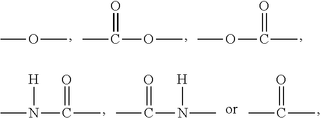
or an alkylene group of 1 to 3 carbons; R₉ is 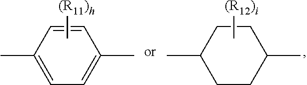
wherein R₁₁ and R₁₂ respectively are a hydrogen atom, a fluorine atom or a methyl group; R₁₀ is a hydrogen atom, a fluorine atom, an alkyl group of 1 to 12 carbons, a fluoroalkyl group of 1 to 12 carbons, an alkoxyl group of 1 to 12 carbons, —OCH₂F, —OCHF₂ or —OCF₃; a is 1 or 2; b, c and d respectively are an integer of 0 to 4; e, f, and g respectively are an integer of 0 to 3, and (e+f+g)≧1; h and i respectively are 1 or 2; when R₅, R₆, R₇, R₈, R₉, R₁₀, R₁₁ and R₁₂ are pluralities, R₅, R₆, R₇, R₈, R₉, R₁₀, R₁₁ and R₁₂ respectively are the same or different.

2. The liquid crystal alignment agent of claim 1, based on the tetracarboxylic dianhydride component (a) as 100 moles, an amount of the tetracarboxylic dianhydride compound (a-1) including a group consisting of a structure of the formula (I-1)to (I-3) is 20 moles to 100 moles.

3. The liquid crystal alignment agent of claim 1, based on the diamine component (b) as 100 moles, an amount of the diamine compound (b-1) having a structure of formula having a structure of formula (II-1) is 1 mole to 50 moles.

4. The liquid crystal alignment agent of claim 1, the liquid crystal alignment agent further comprises an epoxy compound.

5. The liquid crystal alignment agent of claim 1, wherein an imidization ratio of the polymer (A) is 30% to 95%.

6. A liquid crystal alignment film formed by a liquid crystal alignment agent of claim 1.

7. A liquid crystal display element comprising a liquid crystal alignment film of claim 6.
